(19) United States
(12) Patent Application Publication
(10) Pub. No.: US 2013/0124784 A1
(43) Pub. Date: May 16, 2013

(54) MEMORY SYSTEM COMPRISING NONVOLATILE MEMORY DEVICE AND RELATED METHOD OF OPERATION

(71) Applicants: SEONGHOON WOO, HWASEONG-SI (KR); HAKSUN KIM, SUWON-SI (KR)

(72) Inventors: SEONGHOON WOO, HWASEONG-SI (KR); HAKSUN KIM, SUWON-SI (KR)

(73) Assignee: SAMSUNG ELECTRONICS CO., LTD., SUWON-SI (KR)

(21) Appl. No.: 13/604,735

(22) Filed: Sep. 6, 2012

(30) Foreign Application Priority Data
Nov. 15, 2011 (KR) 10-2011-0118923

(51) Int. Cl. G06F 12/00

(52) U.S. Cl. 711/103; 711/E12.008

(57) ABSTRACT

A method of programming a nonvolatile memory device comprises receiving write data, detecting an address of a multi-level cell area associated with the write data, randomizing the write data using the address and programming the randomized data in a single-level cell area.

### CROSS-REFERENCE TO RELATED APPLICATIONS

This application claims priority under 35 U.S.0 §119 to Korean Patent Application No. 10-2011-0118923 filed on Nov. 15, 2011, the subject matter of which is hereby incorporated by reference.

### BACKGROUND OF THE INVENTION

The inventive concept relates generally to electronic memory technologies. More particularly, the inventive concept relates to memory systems comprising one or more nonvolatile memory devices and related methods of operation.

Semiconductor memory devices can be roughly divided into two categories according to whether they retain stored data when disconnected from power. These categories include volatile memory devices, which lose stored data when disconnected from power, and nonvolatile memory devices, which retain stored data when disconnected from power. Examples of volatile memory devices include dynamic random access memory (DRAM) and static random access memory (SRAM). Examples of nonvolatile memory include mask read only memory (MROM), programmable read only memory (PROM), erasable programmable read only memory (EPROM), and electrically erasable programmable read only memory (EEPROM).

Some nonvolatile memory devices are capable of storing more than one bit of data per memory cell. Such nonvolatile memory devices are commonly referred to as multi-bit nonvolatile memory devices or multi-level cell (MLC) nonvolatile memory devices. Nonvolatile memory devices that store more than one bit of data per memory cell may provide higher storage capacity than those that store only one bit of data per memory cell. However, they may suffer from slower operation and reduced reliability, among other things. Accordingly, researchers are engaged in ongoing efforts to improve these and other performance aspects of MLC nonvolatile memory devices.

### SUMMARY OF THE INVENTION

According to an embodiment of the inventive concept, a method is provided for programming a nonvolatile memory device comprising a single-level cell area comprising memory cells each configured to store one bit of data and a multi-level cell area comprising memory cells each configured to store two or more bits of data. The method comprises receiving write data, detecting an address of the multi-level area associated with the write data, randomizing the write data using the address and programming the randomized data in the single-level cell area.

According to another embodiment of the inventive concept, a memory system comprises a nonvolatile memory device comprising a single-level cell area having memory cells each configured to store one bit of data and a multi-level cell area having memory cells each configured to store two or more bits of data, and a controller configured to control the nonvolatile memory device, wherein the controller randomizes write data using an address of the multi-level cell area and controls the nonvolatile memory device to program the randomized write data in the single-level cell area.

According to still another embodiment of the inventive concept, a method of programming a nonvolatile memory device comprises receiving write data and an address, randomizing the write data based on the address, programming the randomized write data in a first area of the nonvolatile memory device comprising memory cells configured to store m-bit data, and programming the randomized write data in a second area of the nonvolatile memory device comprising memory cells configured to store n-bit data, where m is less than n, and wherein the address indicates a location of the second area where the randomized write data is to be stored.

These and other embodiments of the inventive concept can potentially improve reliability and performance of MLC nonvolatile memory devices.

### BRIEF DESCRIPTION OF THE DRAWINGS

The drawings illustrate selected embodiments of the inventive concept. In the drawings, like reference numbers indicate like features.

FIG. 1 is a block diagram of a memory system comprising a nonvolatile memory device according to an embodiment of the inventive concept.

FIG. 2 is a flowchart illustrating a method of programming the nonvolatile memory device of FIG. 1 according to an embodiment of the inventive concept.

FIG. 3 is a flowchart illustrating a first step of a 3-step programming approach used to program memory cells in a multi-level cell area of the nonvolatile memory device of FIG. 1 according to an embodiment of the inventive concept.

FIG. 4 is a diagram illustrating threshold voltage distributions of memory cells in single-level cell and multi-level cell areas during the first step illustrated in FIG. 3.

FIG. 5 is a flowchart illustrating a second step of the 3-step programming approach according to an embodiment of the inventive concept.

FIG. 6 is a diagram illustrating threshold voltage distributions of memory cells in single-level cell and multi-level cell areas during coarse programming according to an embodiment of the inventive concept.

FIG. 7 is a flowchart illustrating a third step of the 3-step programming approach according to an embodiment of the inventive concept.

FIG. 8 is a diagram illustrating threshold voltage distributions of memory cells in single-level cell and multi-level cell areas during fine programming according to an embodiment of the inventive concept.

FIG. 9 is a diagram illustrating a single-level area/multi-level area (SA-MA) address table according to an embodiment of the inventive concept.

FIG. 10 is a block diagram of a memory system according to another embodiment of the inventive concept.

FIG. 11 is a block diagram of a memory system comprising the memory system of FIG. 1 according to an embodiment of the inventive concept.

FIG. 12 is a diagram of a memory card according to an embodiment of the inventive concept.

FIG. 13 is a diagram of a solid state drive according to an embodiment of the inventive concept.

FIG. 14 is a block diagram of a computing system according to an embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, the terms first, second, third, etc. may be used to describe various features, but the described features are not to be limited by these terms. These terms are used merely to distinguish between different features, so a first feature could alternatively be termed a second feature, and vice versa, without changing the meaning of the relevant description.

The terminology used herein is for the purpose of describing particular embodiments only and is not intended to limit the inventive concept. As used herein, the singular forms “a”, “an” and “the” are intended to encompass the plural forms as well, unless the context clearly indicates otherwise. The terms “comprises” and/or “comprising,” when used in this specification, indicate the presence of stated features but do not preclude the presence or addition of other features. As used herein, the term “and/or” indicates any and all combinations of one or more of the associated listed items.

Where a feature is referred to as being “on”, “connected to”, “coupled to”, or “adjacent to” another feature, it can be directly on, connected, coupled, or adjacent to the other feature, or intervening features may be present. In contrast, where a feature is referred to as being “directly on,” “directly connected to”, “directly coupled to”, or “immediately adjacent to” another feature, there are no intervening features present.

Unless otherwise defined, all terms (including technical and scientific terms) used herein have the same meaning as commonly understood by one of ordinary skill in the art. Terms such as those defined in commonly used dictionaries should be interpreted as having a meaning consistent with their meaning in the context of the relevant art and/or the present specification and will not be interpreted in an idealized or overly formal sense unless expressly so defined herein.

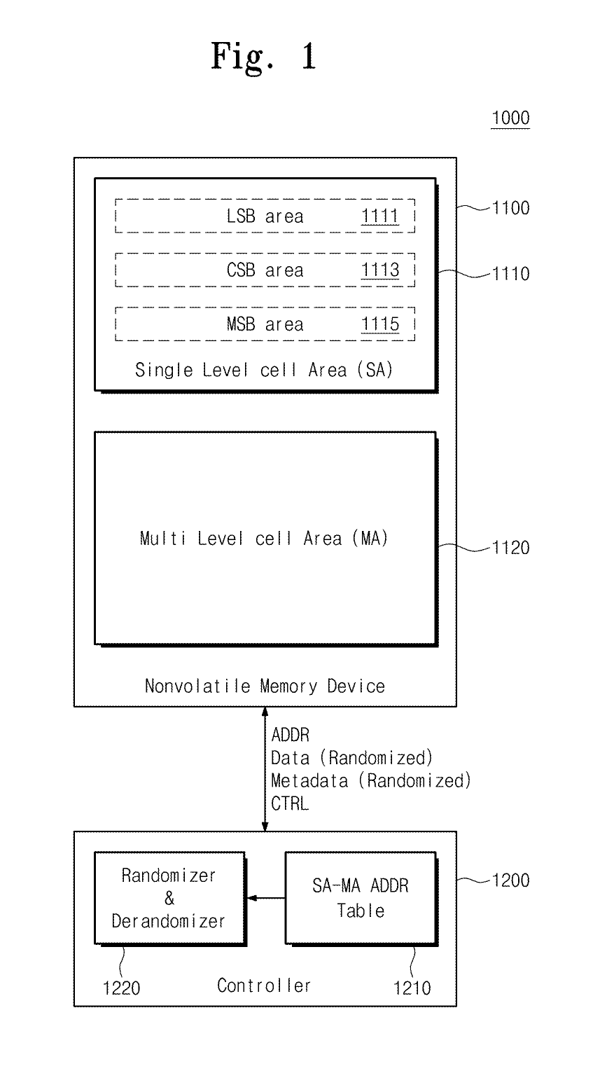

FIG. 1 is a block diagram of a memory system 1000 comprising a nonvolatile memory device 1100 according to an embodiment of the inventive concept.

Referring to FIG. 1, memory system 1000 comprises nonvolatile memory device 1100 and a controller 1200.

Nonvolatile memory device 1100 performs program, read, erase, and background operations under control of controller 1200. Nonvolatile memory device 1100 can be, for example, a NAND flash memory.

Nonvolatile memory device 1100 comprises a single-level cell area (SA) 1110 and a multi-level cell area (MA) 1120. Single-level cell area 1110 comprises a plurality of memory cells each configured to store 1-bit data. Multi-level cell area 1120 comprises a plurality of memory cells each configured to store two or more bits of data. Single-level cell area 1110 and multi-level cell area 1120 are divided into memory blocks.

Single-level cell area 1110 comprises a Least Significant Bit (LSB) area 1111, a Central Significant Bit (CSB) area 1113, and a Most Significant Bit (MSB) area 1115. One bit is stored in memory cells of areas 1111, 1113, and 1115, respectively. LSB, CSB, and MSB area 1111, 1113, and 1115 are divided into memory blocks.

Controller 1200 controls program, read, erase, and background operations of nonvolatile memory device 1100. Controller 1200 provides nonvolatile memory device 1100 with an address ADDR, data, metadata, and a control signal CTRL.

Address ADDR comprises an address associated with memory cells of nonvolatile memory device 1100 in which data is to be programmed, an address associated with memory cells of nonvolatile memory device 1100 from which data is to be read, or an address associated with memory cells of nonvolatile memory device 1100 to be erased.

The data comprises data to be programmed in nonvolatile memory device 1100 or data read out from nonvolatile memory device 1100. The data can include data randomized by controller 1200.

The metadata comprises metadata to be programmed in nonvolatile memory device 1100 or metadata read out from nonvolatile memory device 1100. The metadata typically comprises information used to control nonvolatile memory device 1100, such as information on data characteristics, information on statuses of nonvolatile memory device 1100, information for error correction, and so on. The metadata can include metadata randomized by controller 1200.

Control signal CTRL comprises various signals generated by controller 1200 to control nonvolatile memory device 1100. Controller 1200 comprises a single-level area/multi-level area (SA-MA) address table 1210 and a randomizer and de-randomizer 1220.

SA-MA address table 1210 comprises information on correlations between addresses of memory cells in multi-level cell area 1120 and addresses of memory cells in single-level cell area 1110. For example, addresses (e.g., page addresses) of memory cells connected to a word line of multi-level cell area 1120 may be associated with an address of memory cells connected to a word line of LSB area 1111, an address of memory cells connected to a word line of CSB area 1113, and an address of memory cells connected to a word line of MSB area 1115.

Memory cells connected to a word line of multi-level cell area 1120 typically store LSB data, CSB data, and MSB data. More specifically, they store a page of LSB data (an LSB page), a page of CSB data (a CSB page), and a page of MSB data (an MSB page). Different page addresses are assigned to the LSB, CSB, and MSB pages.

Memory cells connected to a word line of single-level cell area 1110 store one page of data. One page address is assigned to a page of memory cells connected to a word line.

An address of an LSB page in a word line of multi-level cell area 1120 is associated with a page address of a word line in LSB area 1111. An address of a CSB page in a word line of multi-level cell area 1120 is associated with a page address of a word line in CSB area 1113. An address of an MSB page in a word line of multi-level cell area 1120 is associated with a page address of a word line in MSB area 1115.

SA-MA address table 1210 comprises information on correlations between addresses of multi-level cell area 1120 and addresses of single-level cell area 1110.

Randomizer and de-randomizer 1220 is configured to randomize write data to be programmed in nonvolatile memory device 1100 in a program operation and to de-randomize data read out from nonvolatile memory device 1100 in a read operation. For example, in a program operation, randomizer and de-randomizer 1220 randomizes write data using an address of nonvolatile memory device 1100 at which the write data is to be programmed, as a seed. Randomizer and de-randomizer 1220 can perform randomization using addresses of multi-level cell area 1120. Data programmed in single-level cell area 1110 can be randomized according to addresses of multi-level cell area 1120.

An address of multi-level cell area 1120 related to a specific address may be accessed from SA-MA address table 1210 to randomize write data to be programmed in memory cells of the specific address. The write data to be programmed in memory cells of the specific address of single-level cell area 1110 may be randomized using the accessed address of multi-level cell area 1120 as a seed.

In a read operation, randomizer and de-randomizer 1220 de-randomizes read data using an address (e.g., a page address) of memory cells, from which data is read, as a seed.

Where data is read out from multi-level cell area 1120, randomizer and de-randomizer 1220 performs de-randomization using an address. Where data is read out from single-level cell area 1110, randomizer and de-randomizer 1220 detects an address of multi-level cell area 1120 associated with an address from SA-MA address table 1210 and performs de-randomization using the detected address. The de-randomized data is transferred to a host outside of controller 1200.

Randomizer and de-randomizer 1220 also randomizes and de-randomizes metadata with write data. Randomizer and de-randomizer 1220 randomize metadata generated in a program operation and sends the randomized metadata to nonvolatile memory device 1100 with randomized data. In a read operation, randomizer and de-randomizer 1220 reads data and metadata to de-randomize the read data and metadata.

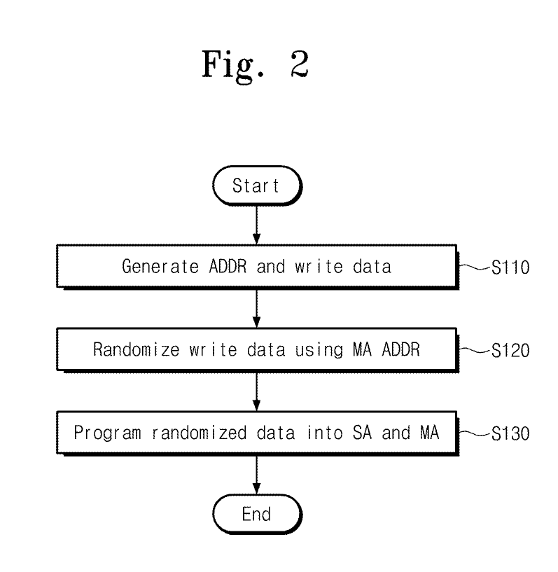

FIG. 2 is a flowchart illustrating a method of programming nonvolatile memory device 1100 of FIG. 1 according to an embodiment of the inventive concept.

Referring to FIGS. 1 and 2, in operation S110, an address and write data are generated. For example, controller 1200 may receive an address and write data from an external source such as a host. Controller 1200 typically receives a logical address from the host and converts the logical address into a physical address of nonvolatile memory device 1100. Controller 1200 can further generate metadata based on the write data, the address, a status of nonvolatile memory device 1100, and other information.

In operation S120, the write data is randomized using an address of multi-level cell area 1120. Even where the write data is data to be programmed in single-level cell area 1110, it may be randomized using an address of multi-level cell area 1120. This address can be identified in SA-MA address table 1210 and used as a seed. Metadata can be further randomized with the write data.

In operation S130, the randomized data is programmed in single-level cell area 1110 and multi-level cell area 1120. With the randomized data, the randomized metadata can be programmed in single-level cell area 1110 and multi-level cell area 1120.

Metadata and write data are typically randomized together, and randomized metadata is programmed with the randomized write data.

Memory cells of multi-level cell area 1120 store LSB data, CSB data, and MSB data. Programming of the LSB, CSB, and MSB data is performed using a 3-step programming approach. Where programming is performed with the 3-step programming approach, memory cells in single-level cell area 1110 are used as a buffer memory.

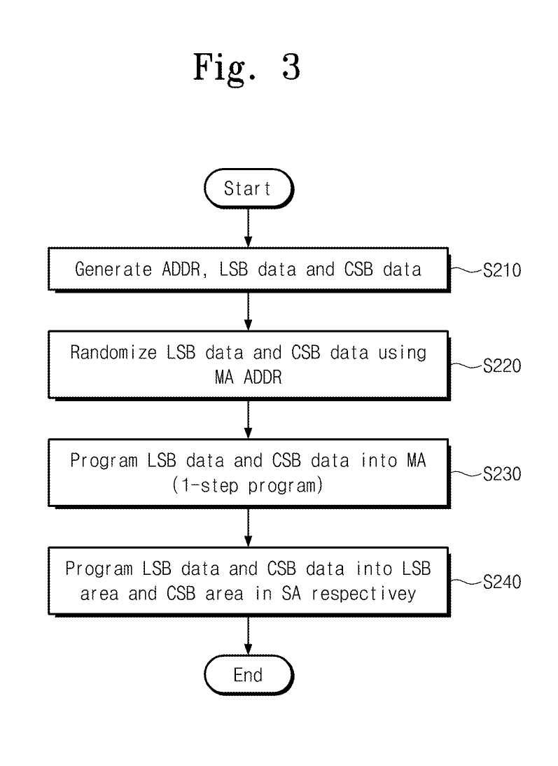

FIG. 3 is a flowchart illustrating a first step of the 3-step programming approach for multi-level cell area 1120 according to an embodiment of the inventive concept.

Referring to FIGS. 1 and 3, in operation S210, LSB data and CSB data are generated. For example, controller 1200 may receive the LSB and CSB data from an external source as write data. Controller 1200 receives an address where the LSB and CSB data are to be programmed. The input address generally identifies a location of multi-level cell area 1120.

In operation S220, the LSB data and the CSB data are randomized using an address of multi-level cell area 1120.

In operation S230, the randomized LSB and CSB data are programmed in multi-level cell area 1120. This programming can be referred to as first-step programming.

In operation S240, the randomized LSB data is programmed in LSB area 1111 of single-level cell area 1110, and the randomized CSB data is programmed in CSB area 1113 thereof.

The LSB data is programmed in memory cells at an address of LSB area 1111 associated with an address of multi-level cell area 1120. For example, the address of LSB area 1111 associated with the address of multi-level cell area 1120 may be acquired from SA-MA address table 1210. The LSB data may be programmed in memory cells of LSB area 1111 corresponding to the acquired address.

Similarly, the CSB data may be programmed in memory cells at an address of CSB area 1113 associated with an address of multi-level cell area 1120. For example, the address of CSB area 1113 associated with the address of multi-level cell area 1120 may be acquired from SA-MA address table 1210. The CSB data may be programmed in memory cells of CSB area 1113 corresponding to the acquired address.

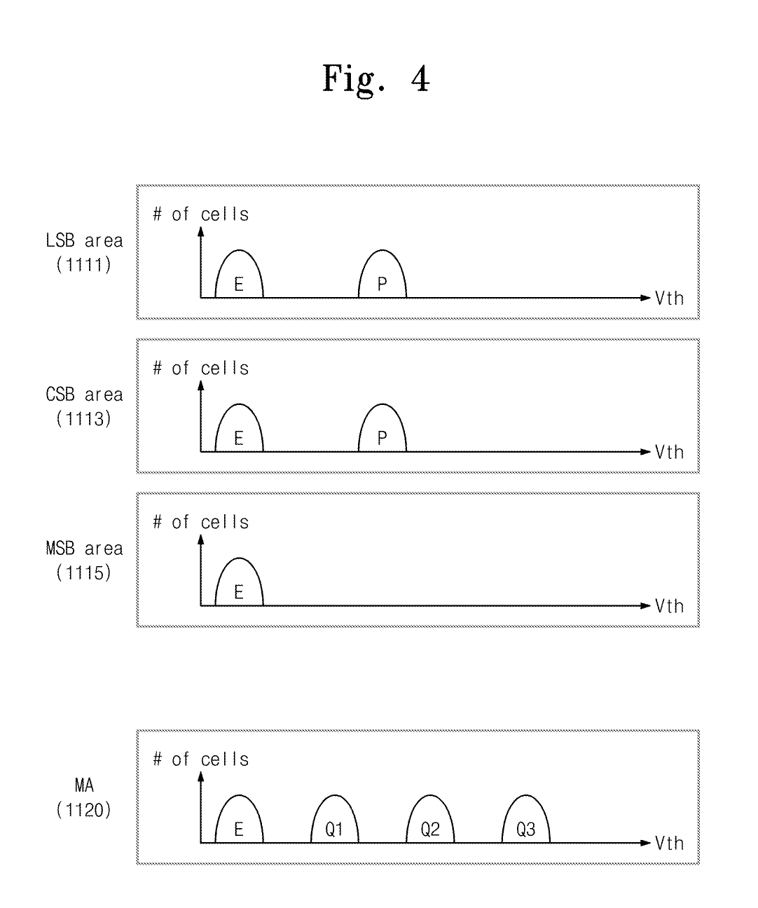

FIG. 4 is a diagram illustrating threshold voltage distributions of memory cells in single-level cell area 1110 and multi-level cell area 1120 during the first step illustrated in FIG. 3 according to an embodiment of the inventive concept. More particularly, FIG. 4 shows threshold voltage distributions of memory cells connected to a word line of multi-level cell area 1120 and threshold voltage distributions of memory cells connected to a word line of each of LSB, CSB, and MSB areas 1111, 1113, and 1115 associated with one word line of single-level cell area 1110.

Referring to FIG. 4, 2-bit data comprising LSB data and CSB data is programmed in memory cells connected to a word line of multi-level cell area 1120. The memory cells may have any one of an erase state E and program states Q1 through Q3. 1-bit data comprising LSB data is programmed in memory cells connected to a word line of LSB area 1111. The memory cells may have erase state E or a program state P. 1-bit data comprising CSB data is programmed in memory cells connected to a word line of CSB area 1113. The memory cells may have erase state E or program state P. Memory cells connected to a word line of MSB area 1115 retain erase state E.

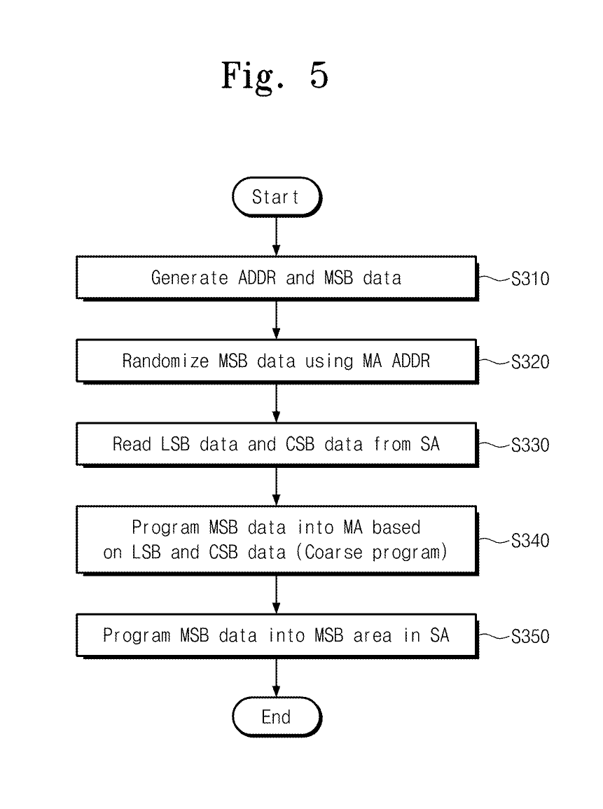

FIG. 5 is a flowchart illustrating a second step of the 3-step programming approach according to an embodiment of the inventive concept.

Referring to FIGS. 1 and 5, in operation S310, MSB data is generated. For example, controller 1200 may receive MSB data from an external source as write data. It may also receive an address at which the MSB data is to be programmed. The input address may point at a multi-level cell area 1120.

In operation S320, the MSB data is randomized using an address of multi-level cell area 1120.

In operation S330, LSB data and CSB data are read from single-level cell area 1110. The LSB data is read from LSB area 1111, and the CSB data is read from CSB area 1113.

In operation S340, the randomized MSB data is programmed in multi-level cell area 1120 based on the read LSB and CSB data. This programming constitutes coarse programming.

In operation S350, the randomized MSB data is programmed in single-level cell area 1110. For example, an address of MSB area 1115 associated with an address of multi-level cell area 1120 may be acquired from SA-MA address table 1210. The MSB data may be programmed in memory cells of MSB area 1115 corresponding to the acquired address.

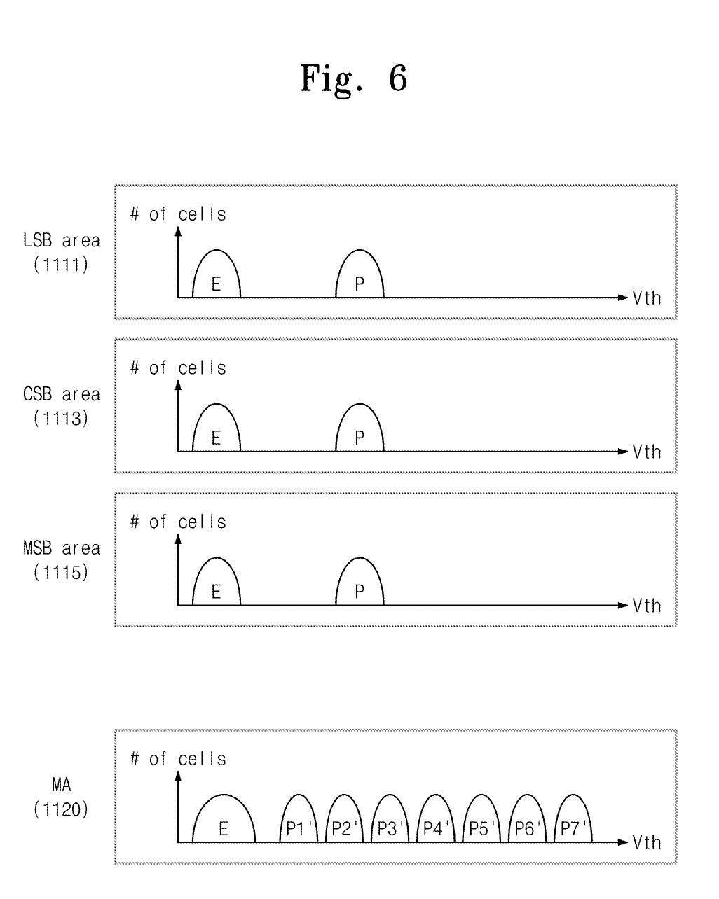

FIG. 6 is a diagram illustrating threshold voltage distributions of memory cells in single-level cell and multi-level cell areas during coarse programming according to an embodiment of the inventive concept. In particular, FIG. 6 illustrates threshold voltage distributions of memory cells connected to a word line of a multi-level cell area 1120 and threshold voltage distributions of memory cells connected to a word line of each of LSB, CSB, and MSB areas associated with a word line of single-level cell area 1110.

Referring to FIGS. 4 and 6, 1-bit data comprising MSB data is further programmed in each of memory cells connected to a word line of multi-level cell area 1120. These memory cells may have any one of an erase state and program states P1′ through P7′. 1-bit data comprising the MSB data is programmed in each of memory cells connected to a word line of MSB area 1115. These memory cells may have erase state E or a program state P.

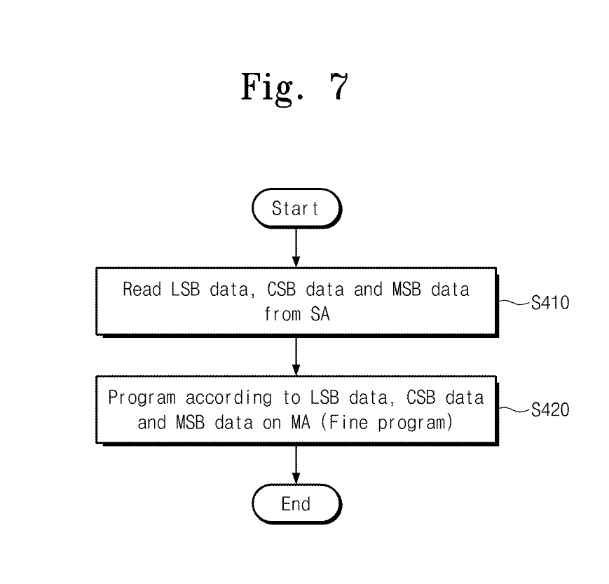

FIG. 7 is a flowchart illustrating a third step of the 3-step programming approach according to an embodiment of the inventive concept.

Referring to FIGS. 1 and 7, in operation S410, LSB data, CSB data, and MSB data are read out from single-level cell area 1110. The LSB data is read from LSB area 1111, the CSB data is read from CSB area 1113, and the MSB data is read from an MSB area 1115.

In operation S420, programming of multi-level cell area 1120 is performed based on the LSB, CSB, and MSB data. This programming constitutes fine programming.

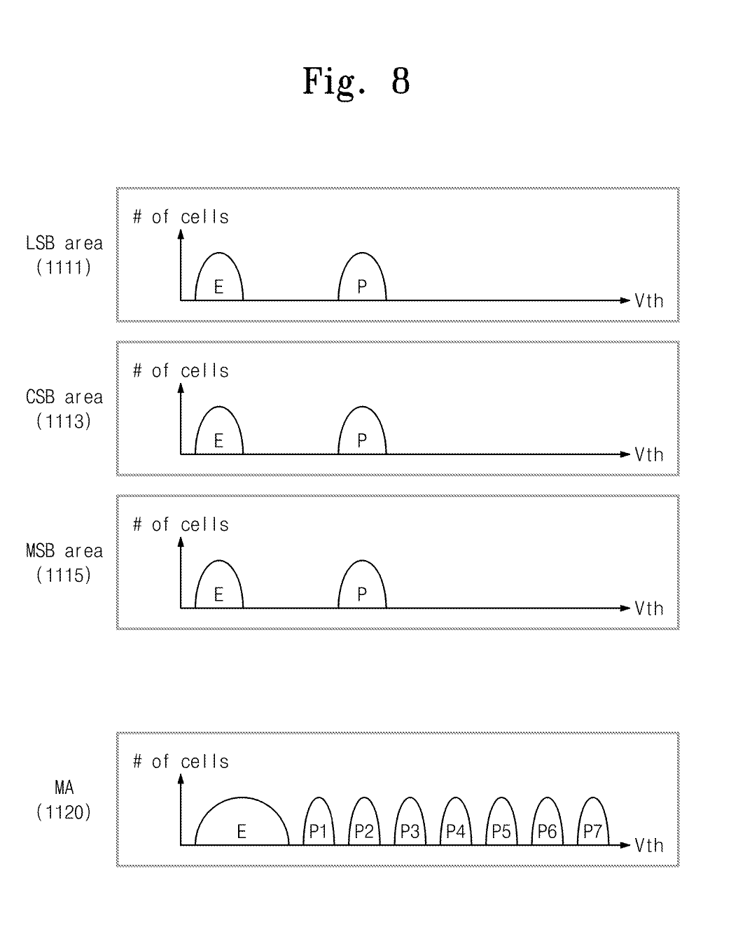

FIG. 8 is a diagram illustrating threshold voltage distributions of memory cells in single-level cell and multi-level cell areas during fine programming according to an embodiment of the inventive concept. In particular, FIG. 8 illustrates threshold voltage distributions of memory cells connected to a word line of a multi-level cell area 1120 and threshold voltage distributions of memory cells connected to a word line of each of LSB, CSB, and MSB areas associated with a word line of single-level cell area 1120.

Referring to FIGS. 7 and 8, memory cells of multi-level cell area 1120 are programmed to have a narrower threshold voltage distribution at higher voltage levels.

After programming is performed on a first word line of multi-level cell area 1120, programming is performed on a second word line adjacent to the first word line. The programming can be performed with respect to both of the first and second word lines using 1-step programming, coarse programming, or fine programming, for example. After the programming is performed on the second word line, memory cells of the first word line may experience coupling, which may widen their threshold voltage distributions.

Where memory cells of the first and second word lines are 1-step programmed, a threshold voltage distribution of memory cells in the first word line may widen. Where coarse programming is carried out on memory cells of the first word line, a threshold voltage distribution of the memory cells of the first word line may become narrow (refer to FIG. 6). Because the coarse programming performed on the memory cells of the first word line is made according to LSB data and CSB data read out from single-level cell area 1110, the coarse programming performed on the memory cells of the first word line may not be affected by the coupling generated in 1-step programming performed on the second word line.

Where coarse programming is performed on memory cells of the second word line, a threshold voltage distribution of the memory cells in the first word line may widen. Where fine programming is performed on the memory cell in the first word line, a threshold voltage distribution of the memory cells in the first word line may become narrow (refer to FIG. 8). Because the fine programming is performed on the memory cells of the first word line based on LSB data, CSB data, and LSB data read out from single-level cell area 1110, the fine programming performed on the memory cells in the first word line may not be affected by the coupling generated by coarse programming performed on the second word line.

Where the fine programming is performed on memory cells of the second word line, a threshold voltage distribution of the memory cells in the first word line may widen. However, referring to FIGS. 6 and 8, a variation in threshold voltages of memory cells in fine programming may be less than a variation in threshold voltages of memory cells in 1-step programming and coarse programming. That is, the coupling effect when fine programming is made on the memory cells of the second word line may be less that that when 1-step programming and coarse programming are performed on the memory cells in the second word line.

As described above, where programming is performed using a 3-step programming approach, it is possible to minimize a coupling effect experienced by programmed memory cells in multi-level cell area 1120 (i.e., fine-programmed memory cells). Programming performed using the 3-step programming approach using single-level cell area 1110 as a buffer may be referred to as On-chip Buffered Programming (OBP).Coarse programming and fine programming of multi-level cell area 1120 may be performed based on data programmed in single-level cell area 1110. Where write data programmed in nonvolatile memory device 1100 is randomized according to an address (or, a page address), randomized data programmed in single-level cell area 1110 may be different in pattern from that programmed in multi-level cell area 1120. Where patterns of randomized data are different, a program error may happen when data read from single-level cell area 1110 is programmed in multi-level cell area 1120. As described above, OBP may be carried out without an error by randomizing data programmed in single-level cell area 1110 using an address (or, a page address) of multi-level cell area 1120.

Where data being programming in nonvolatile memory device 1100 has a specific pattern, the reliability of the programmed data may suffer. For example, where data having the same pattern is programmed in multiple pages, an electric field among memory cells may be reinforced, so that charges accumulated or trapped at memory cells are discharged. It is possible to prevent a specific pattern from being programmed in nonvolatile memory device 1100 by randomizing data (including write data and metadata) and programming the randomized data. Thus, the reliability of data programmed in nonvolatile memory device 1100 may be improved.

In another embodiment, the OBP may be executed in different ways. For example, the OBP may comprise a SA programming step and a MA programming step. Upon receiving LSB data, the controller 1200 may randomize the received LSB data using an address of MA 1120 and program the randomized LSB data into LSB area 1111. Upon receiving CSB data, the controller may randomize the received CSB data using the address of MA 1120 and program the randomized CSB data into CSB area 1113. Upon receiving MSB data, the controller may randomize the received MSB data using the address of MA 1120 and program the randomized MSB data into MSB area 1115. Programs of randomized LSB, CSB and MSB data into SA 1110 may form the SA programming step.

Then, the controller may read the randomized LSB, CSB and MSB data from SA 1110, and program them into MA 1120. Programs of randomized LSB, CSB and MSB data into MA 1120 may form the MA programming step. The MA programming step may be conducted when the controller 1200 or the nonvolatile memory device 1100 is at an idle state.

A programming of SA 1110 may be faster than that of MA 1120. According to another embodiment of the OBP, received data are programmed into SA 1110. The programmed data are copied to MA 1120 during an idle state. Thus, response time of the controller 1200 or the nonvolatile memory device 1100 is reduced.

As described above, the OBP may be executed to advance reliability or to reduce response time of the controller 1200 or the nonvolatile memory device 1100. Although the OBP is executed in different ways according to its purpose, the OBP commonly include randomizing received data using an address of MA, programming the randomized data into SA 1110, reading the randomized data from SA 1110, and programming the randomized data into MA 1120 regardless its purpose.

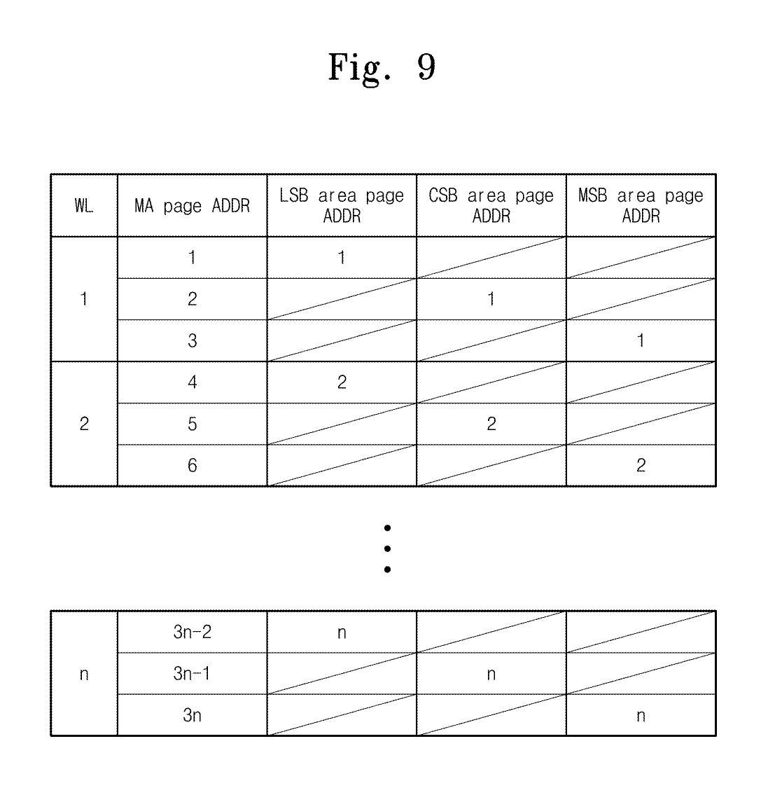

FIG. 9 is a diagram illustrating an SA-MA address table according to an embodiment of the inventive concept.

Referring to FIG. 9, a first column indicates a word line. A second column indicates a page address of multi-level cell area 1120. A third column indicates a page address of LSB area 1111. A fourth column indicates a page address of CSB area 1113. A fifth column indicates page address of an MSB area 1115.

In multi-level cell area 1120, three page addresses are assigned to a word line. For example, three page addresses may comprise an LSB page address, a CSB page address, an MSB page address. In each of LSB, CSB, and MSB areas 1111, 1113, and 1115 of single-level cell area 1110, a page address may be assigned to a word line.

A first page address (1) of a first word line (1) in multi-level cell area 1120 is associated with a page address (1) of a first word line (1) in LSB area 1111. A second page address (2) of the first word line (1) in multi-level cell area 1120 is associated with a page address (1) of a first word line (1) in CSB area 1113. A third page address (3) of the first word line (1) in multi-level cell area 1120 is associated with a page address (1) of a first word line (1) in MSB area 1115.

Page addresses (4 through 6) of a second word line (2) in multi-level cell area 1120 are associated with a page address (2) of a second word line (2) in LSB area 1111, a page address (2) of a second word line (2) in CSB area 1113, and a page address (2) of a second word line (2) in MSB area 1115, respectively.

Page addresses (3n-2 through 3n) of an n-th word line (n) in multi-level cell area 1120 is associated with a page address (n) of an n-th word line (n) in LSB area 1111, a page address (n) of an n-th word line (n) in CSB area 1113, and a page address (n) of an n-th word line (n) in MSB area 1115, respectively.

That is, page addresses of a word line in multi-level cell area 1120 are associated with a page address of a word line in LSB area 1111, a page address of a word line in CSB area 1113, and a page address of a word line in MSB area 1115, respectively.

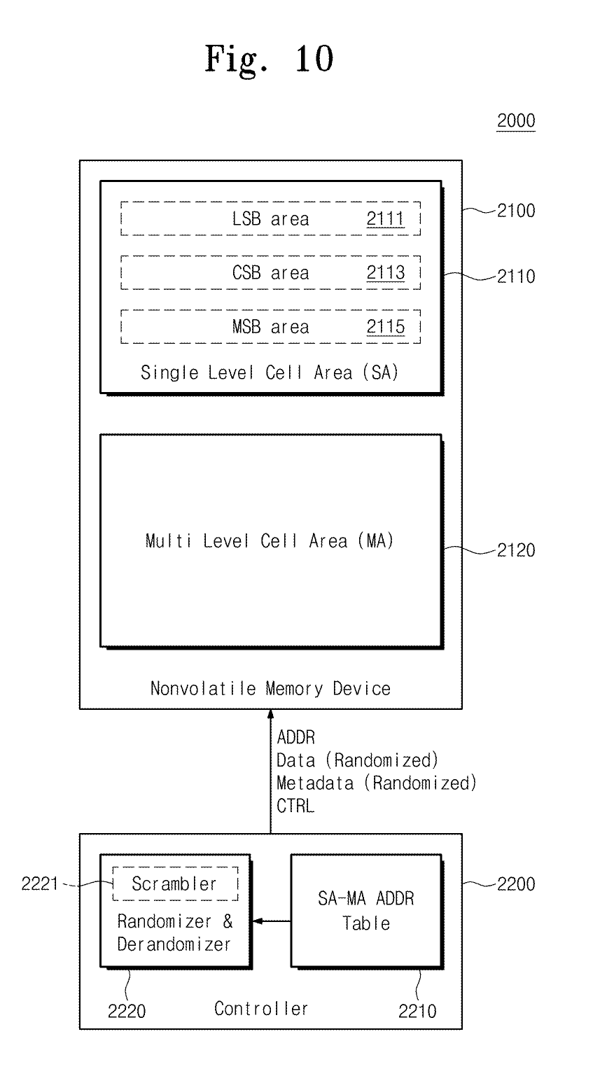

FIG. 10 is a block diagram of a memory system 2000 according to another embodiment of the inventive concept. Memory system 2000 is similar to memory system 1000 of FIG. 1, except that it comprises a controller 2200 comprising a scrambler 2221 within a randomizer and de-randomizer 2220.

Referring to FIG. 10, memory system 2000 comprises a nonvolatile memory device 2100 and a controller 2200. Nonvolatile memory device 2100 comprises a single-level cell area 2110 and a multi-level cell area 1120, which are similar to single-level cell area 1110 and multi-level cell area 1120 of FIG. 1. Single-level cell area 2110 comprises an LSB area 2111, a CSB area 2113, and an MSB area 2115, which are similar to LSB area 1111, CSB area 1113, and MSB area 1115 of FIG. 1.

Controller 2200 comprises randomizer and de-randomizer 2220, which is similar to randomizer and de-randomizer 1220, except that it further comprises scrambler 2221. Controller 2200 further comprises an SA-MA address table 2210, which is similar to SA-MA address table 1210 of FIG. 1.

Scrambler 2221 scrambles an address used as a seed. For example, scrambler 2221 may scramble an address of multi-level cell area 2120 used as a seed. Randomizer and de-randomizer 2220 perform randomizing or de-randomizing using an address scrambled by scrambler 2221 as a seed. Some addresses of addresses of multi-level cell area 2120 may have a simple pattern. For example, some addresses of addresses of multi-level cell area 2120 may have a simple pattern such as ‘00000001’, ‘00000010’, or ‘00000100’. An effect obtained by randomizing write data may be lowered by randomizing the write data using a simple pattern.

The scrambled seed may have a random property. Lowering an effect obtained by randomizing write data may be prevented by using a pattern with the random property that addresses of multi-level cell area 2120 are scrambled, as a seed.

Scrambler 2221 typically scrambles addresses of multi-level cell area 2120 using an operation between adjacent bits (e.g., AND, exclusive-OR, etc.), or bit-swapping between adjacent bits.

Although FIGS. 1 and 10 present examples where memory cells in multi-level cell areas 1120 and 2120 store 3-bit data, the number of bits stored in each memory cell of a multi-level cell area is not limited to three. In general, where m-bit data is stored in each memory cell of multi-level cell area 1120 or 2120, single-level cell area 1110 or 2110 may be divided into m areas. A word line of multi-level cell area 1120 or 2120 may be associated with word lines each included in the respective m areas of single-level cell area 1110 and 2110. Correlation information may be stored in SA-MA address table 1210 or 2210.

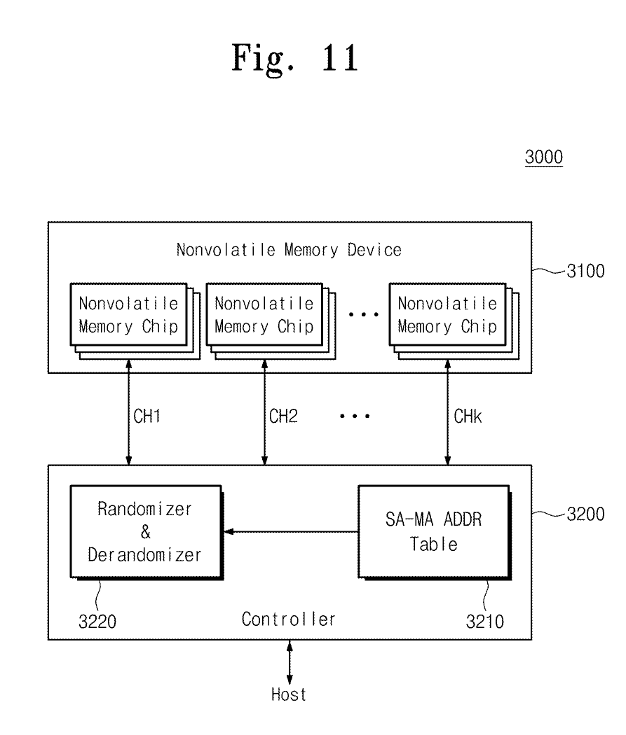

FIG. 11 is a block diagram of a memory system 3000 comprising a nonvolatile memory device 3100 according to an embodiment of inventive concept. Memory system 3000 is a variation of memory system 1000 illustrated in FIG. 1.

Referring to FIG. 11, memory system 3000 comprises nonvolatile memory device 3100 and a controller 3200. Nonvolatile memory device 3100 comprises a plurality of nonvolatile memory chips arranged in a plurality of groups. Nonvolatile memory chips in each group are configured to communicate with controller 3200 via one common channel. The plurality of nonvolatile memory chips communicate with controller 3200 via a plurality of channels CH1 through CHk.

Controller 3200 comprises an SA-MA address table 3210 and a randomizer and de-randomizer 3220. Similar to embodiments described in relation to FIGS. 1 through 9, controller 3200 randomizes or de-randomizes data using addresses of a multi-level cell area. Also, similar to the embodiment described in relation to FIG. 10, randomizer and de-randomizer 3220 may comprise a scrambler. Controller 3200 randomizes or de-randomizes data using a pattern where addresses of the multi-level cell area are scrambled.

In a variation of the embodiment of FIG. 11, memory system 3000 may be modified such that one channel is connected with one nonvolatile memory chip rather than a plurality of nonvolatile memory chips.

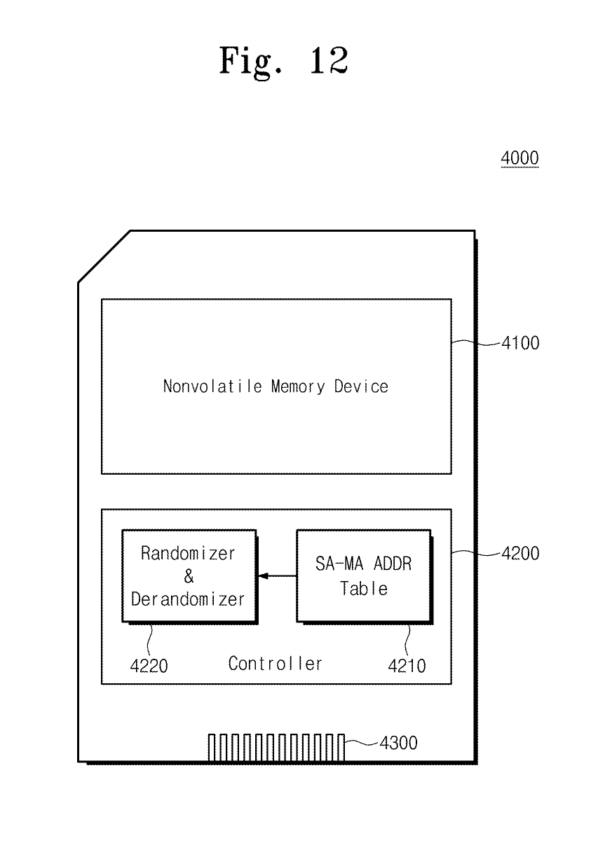

FIG. 12 is a diagram illustrating a memory card 4000 according to an embodiment of the inventive concept.

Referring to FIG. 12, a memory card 4000 comprises a nonvolatile memory device 4100, a controller 4200, and a connector 4300. Nonvolatile memory device 4100 comprises a single-level cell area and a multi-level cell area. Controller 4200 comprises an SA-MA address table 4210 and a randomizer and de-randomizer 4220.

Similar to embodiments described in relation to FIGS. 1 through 9, controller 4200 randomizes or de-randomizes data using addresses of the multi-level cell area. Also, similar to the embodiment described with reference to FIG. 10, randomizer and de-randomizer 4220 may comprise a scrambler. Controller 4200 randomizes or de-randomizes data using a pattern where addresses of the multi-level cell area are scrambled.

Connector 4300 electrically connects memory card 4000 with a host. Memory card 4000 can take various alternative forms, such as a PC or PCMCIA card, a CF card, an SM or SMC card, a memory stick, a multimedia card (e.g., MMC, RS-MMC, or MMCmicro), a security card (e.g., SD, miniSD, microSD, or SDHC), or a universal flash storage (UFS) device, for example.

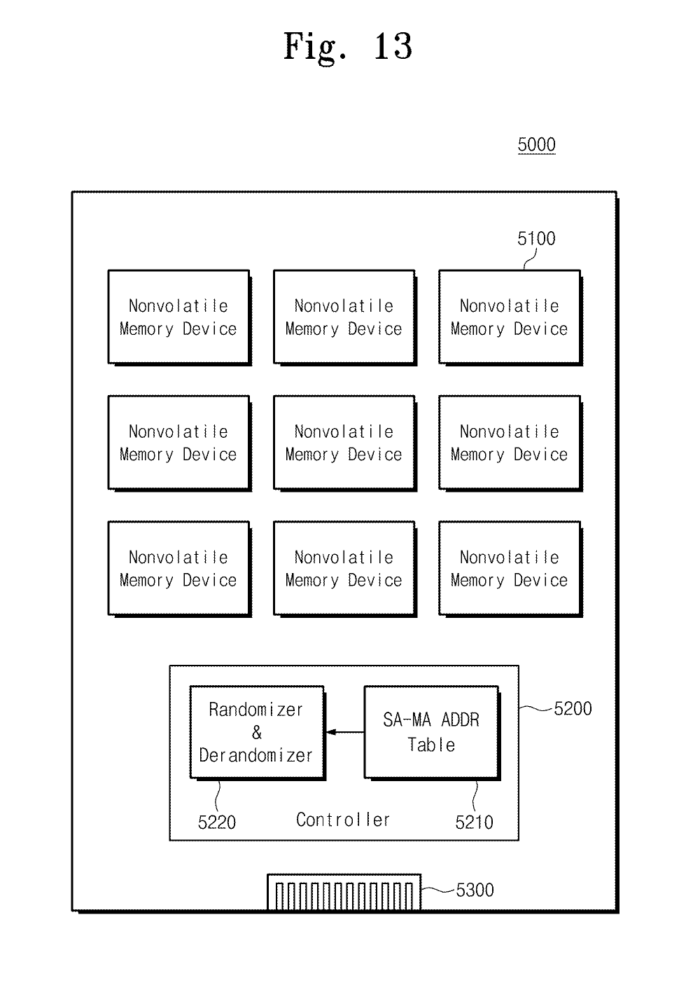

FIG. 13 is a diagram of a solid state drive 5000 according to an embodiment of the inventive concept.

Referring to FIG. 13, solid state drive 5000 comprises a plurality of nonvolatile memory devices 5100, a controller 5200, and a connector 5300.

Each of nonvolatile memory devices 5100 comprises a single-level cell area and a multi-level cell area. Some of nonvolatile memory devices 5100 may be single-level cell devices, and others may be multi-level cell devices.

Controller 5200 comprises an SA-MA address table 5210 and a randomizer and de-randomizer 5220. Similar to embodiments described in relation to FIGS. 1 through 9, controller 5200 randomize or de-randomize data using addresses of a multi-level cell area. Also, similar to the embodiment described with reference to FIG. 10, randomizer and de-randomizer 5220 may comprise a scrambler. Controller 5200 randomizes or de-randomizes data using a pattern where addresses of the multi-level cell area are scrambled. Connector 5300 electrically connects solid state drive 5000 with a host.

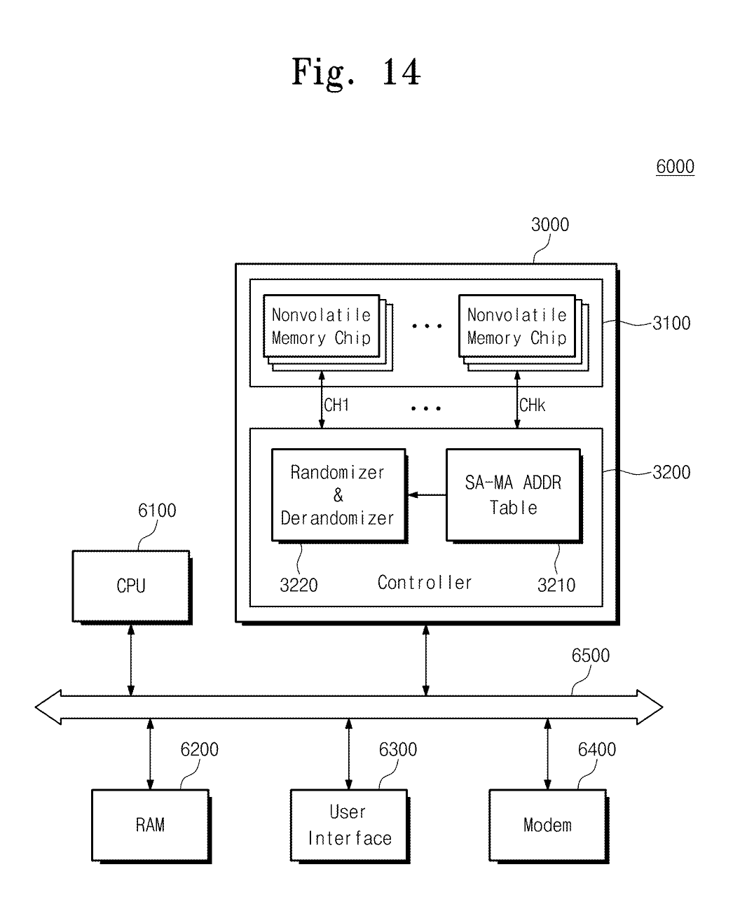

FIG. 14 is a block diagram of a computing system 6000 according to an embodiment of the inventive concept.

Referring to FIG. 14, a computing system 6000 comprises a central processing unit 6100, a RAM 6200, a user interface 6300, a modem 6400, and a memory system 3000.

Memory system 3000 is connected electrically with elements 6100 through 6400 via a system bus 6500. Data provided via user interface 6300 or processed by central processing unit 6100 may be stored in memory system 3000.

In the embodiment of FIG. 14, nonvolatile memory device 3100 is connected to system bus 6500 via controller 3200. However, nonvolatile memory device 3100 can alternatively be electrically connected directly to system bus 6500.

Memory system 3000 of FIG. 14 may be a memory system described in relation to FIG. 11. However, memory system 3000 can be replaced with a memory system 1000 or 2000 described with reference to FIG. 1 or 10.

As indicated by the foregoing, in a nonvolatile memory device comprising a single-level cell area storing 1-bit data per cell and a multi-level cell area storing two or more bits of data per cell, write data may be randomized at OBP in which the single-level cell area is used as an on-chip buffer. It is possible to prevent patterns, which may potentially decrease reliability of data from being programmed in the nonvolatile memory device by randomizing write data. Thus, a program method and a memory system with the improved reliability may be provided.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

What is claimed is:

1. A method of programming a nonvolatile memory device comprising a single-level cell area comprising memory cells each configured to store one bit of data and a multi-level cell area comprising memory cells each configured to store two or more bits of data, the method comprising:
receiving write data;
detecting an address of the multi-level cell area associated with the write data;
randomizing the write data using the address;
programming the randomized data in the single-level cell area.

2. The method of claim 1, wherein randomizing the write data comprises randomizing the write data using the address as a seed.

3. The method of claim 1, wherein randomizing the write data comprises scrambling the address, and randomizing the write data using the scrambled address as a seed.

4. The method of claim 1, wherein the single-level cell area comprises a least significant bit (LSB) area, a central significant bit (CSB) area, and a most significant bit (MSB) area, and a word line in the multi-level cell area is associated with a word line in the LSB area, a word line in the CSB area, and a word line in the MSB area, respectively.

5. The method of claim 4, wherein the write data comprises LSB data, CSB data and MSB data, and
wherein the programming the randomized data comprises:
programming the randomized LSB, CSB and MSB data in memory cells of the LSB area associated with the address, the randomized CSB data in memory cells of the CSB area associated with the address and the randomized MSB data in memory cells of the MSB area associated with the address.

6. The method of claim 5, further comprising:
reading the randomized LSB, CSB and MSB data from the LSB, CSB and MSB area respectively.

7. The method of claim 6, further comprising:
programming the read LSB, CSB and MSB data in memory cells of the multi-level area matched with the address.

8. The method of claim 1, further comprising reading the write data from the single-level cell area, and de-randomizing the read data using the address of the multi-level cell area.

9. A memory system comprising:
a nonvolatile memory device comprising a single-level cell area having memory cells each configured to store one bit of data and a multi-level cell area having memory cells each configured to store two or more bits of data; and
a controller configured to control the nonvolatile memory device, wherein the controller randomizes write data using an address of the multi-level cell area and controls the nonvolatile memory device to program the randomized write data in the single-level cell area.

10. The memory system of claim 9, wherein the single-level cell area comprises a least significant bit (LSB) area, a central significant bit (CSB) area, and a most significant bit (MSB) area, and the controller stores information indicating correlation between addresses corresponding to a word line of the multi-level cell area, a word line of the LSB area, a word line of the CSB area, and a word line of the MSB area, and controls the nonvolatile memory device to program the write data in the single-level cell area according to the stored information.

11. The memory system of claim 9, wherein the controller controls the nonvolatile memory device to access write data programmed in the single-level cell area and to perform reprogramming on the multi-level cell area based on the accessed write data.

12. The memory system of claim 9, wherein the controller scrambles the address of the multi-level cell area and randomizes the write data using the scrambled address.

13. The memory system of claim 9, wherein the nonvolatile memory device and the controller constitute a memory card.

14. The memory system of claim 9, wherein the nonvolatile memory device and the controller constitute a solid state drive.

15. A method of programming a nonvolatile memory device, comprising:
receiving write data and an address;
randomizing the write data based on the address;
programming the randomized write data in a first area of the nonvolatile memory device comprising memory cells configured to store m-bit data; and
programming the randomized write data in a second area of the nonvolatile memory device comprising memory cells configured to store n-bit data, where m is less than n, and wherein the address indicates a location of the second area where the randomized write data is to be stored.

16. The method of claim 15, wherein the write data is randomized using the address as a seed.

17. The method of claim 15, wherein the first area comprises a least significant bit (LSB) area, a central significant bit (CSB) area, and a most significant bit (MSB) area, and a word line of the second area is associated with a word line of the LSB area, a word line in the CSB area, and a word line of the MSB area, respectively.

18. The method of claim 17, wherein the write data comprises LSB data, CSB data and MSB data, and
wherein the programming the randomized data comprises:
programming the randomized LSB, CSB and MSB data in memory cells of the
LSB area associated with the address, the randomized CSB data in memory cells of the CSB area associated with the address and the randomized MSB data in memory cells of the MSB area associated with the address.

19. The method of claim 18, further comprising:
reading the randomized LSB, CSB and MSB data from the LSB, CSB and MSB area respectively.

20. The method of claim 19, further comprising:
programming the read LSB, CSB and MSB data in memory cells of the second area matched with the address.
